(19) United States
(12) Patent Application Publication
(10) Pub. No.: US 2005/0164780 A1
(43) Pub. Date: Jul. 28, 2005

(54) Award money payment system, award ticket issuing device and award ticket accounting device

(75) Inventors: Kazuo Okada, Koto-ku (JP); Jun Fujimoto, Koto-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 11/038,189

(22) Filed: Jan. 21, 2005

(30) Foreign Application Priority Data
Jan. 28, 2004 (JP) 2004-019847

(51) Int. Cl. A63F 9/24; G06F 19/00; G06F 17/00

(52) U.S. Cl. 463/25

(57) ABSTRACT

The present invention provides an award money payment system for paying out a predetermined award money to a user when the user wins an award in a game using a gaming machine. The award money payment system includes an award ticket issuing device which prepares and issues an award ticket which is related with identification information of an award winner when the award winner wins an award in a gaming machine; and an award ticket accounting device which reads out information stored in the award ticket and acquires identification of a bearer of the award ticket, and is instructed to perform the accounting of the award money by distributing an award money into the payout of the award money in cash and the transfer of the award money into an account in accordance with a distribution designation input on the condition that the identification of the bearer of the award ticket based on the identification information is established.

### CROSS-REFERENCES TO THE RELATED APPLICATIONS

This application is based upon and claims the priority from a prior Japanese patent application No. 2004-013424, filed in Japan on Jan. 21, 2004, entire contents of which are incorporated herein by reference.

This application is related to a co-pending U.S. patent application referred to as a prior Japanese patent application No. 2004-019847 filed in Japan on Jan. 28, 2004.

### BACKGROUND OF THE INVENTION

1. Field of the Invention:

The present invention relates to an award money payment system, an award ticket issuing device and an award ticket accounting device, and more particularly to an award money payment system, an award ticket issuing device and an award ticket accounting device which perform the payment of an award money won by a player in a gaming machine or the like, for example, by dividing the manner of payment into the payment which uses a transaction account and the payment in cash based on the distribution designated by the selection of the user.

2. Related Art:

Recently, along with the development of the information communication techniques and the improvement and the spreading of the communication infrastructure, the circulation of various information via the Internet is realized. Also with respect to the transfer of an award money won by a user in a public lottery or the like, a system which makes use of the communication network has been proposed thus allowing a lottery winner to receive the award money without taking the trouble to attend to an award money payout institution such as a clerk of a specified bank.

As a payment/reception technique of the award money of the public lottery, there has been proposed a following technique in Japanese Laid-open Patent Publication 2002-133333 (see paragraphs [0027], [0032], FIG. 4, FIG. 5). That is, this patent document discloses the technique in which, for example, a plurality of items which correspond to the manners of payment when an award money is paid by converting a lottery ticket or a merchandise coupon into cash are displayed on a display device, and the payment is performed in accordance with the manner of payment which is arbitrarily selected by the user among the plurality of displayed items.

### SUMMARY OF THE INVENTION

However, in the above-mentioned payment/reception technique of the award money, it is impossible to determine whether a proper holder of the award ticket such as the public lottery and an owner of a transfer destination account which a bearer of the award ticket designates by selection are the same person or not and hence, it has been difficult to cope with a payout request by an illegal holder or forfeiter of the award ticket.

Accordingly, it is an object of the present invention to provide a method and a system for payment/receiving an award money which performs the personal confirmation of a holder of an award ticket and, at the same time, can pay out an award money to a plurality of transfer destination accounts (including payout in cash) in accordance with the selection by a user at the time of performing the accounting (payment) of the award money based on the award ticket such as the public lottery.

The present invention which can achieve the above-mentioned object has following constitutional features. The first aspect of the present invention is proposed as an award money payment system which pays a predetermined award money to a user when the user wins an award in a game.

The system is characterized by including an award ticket issuing device which issues an award ticket which is related with identification information of the user when the user wins an award in a gaming machine, and an award ticket accounting device which reads out information stored in the award ticket and acquires identification information of a bearer of the award ticket, and is instructed to account and distribute the award money in cash and to transfer the award money into a transfer destination account in accordance with a distribution designation input on the condition that the identification of the bearer of the award ticket based on the identification information is established.

The second aspect of the present invention is proposed as the constitution of the award ticket issuing device.

The award ticket issuing device includes an identification information acquiring unit which acquires identification information of a holder of an award ticket upon reception of a notification of winning of an award, and an award ticket issuing control unit which stores the identification information which is acquired by the identification information acquiring unit and award ticket identification information (an award ticket ID) in a state that the identification information and the award ticket identification information are related to each other.

The third aspect of the present invention is proposed as an award ticket accounting device. The award ticket accounting device includes an input receiving means (a user interface unit) which receives a distribution designation input of an award money by a bearer of an award ticket, an identification information acquiring unit which acquires identification information of the bearer of the award ticket, an award ticket accounting control unit which reads award ticket identification information (award ticket ID) which is stored in the award ticket, acquires the identification information of a holder of the award ticket based on the award ticket identification information, and instructs the input receiving unit to receive the distribution designation input based on a result of identification using the identification information of the bearer of the award ticket acquired by the identification information acquiring unit and the identification information of the holder of the award ticket, and a transfer processing unit which performs the transfer of the whole or a portion of the award money to a transfer destination account in accordance with the distribution designation input.

In this award ticket accounting device, the award ticket accounting device may further include a cash payout unit which pays out a cash in accordance with the distribution designation input.

With respect to the accounting the award ticket, at the time of accounting (paying) the award money based on the award ticket won using a gaming machine, it is possible to perform the identification of the bearer of the award ticket and, at the same time, it is possible to pay out the award money by distributing the award money into a plurality of transfer destination account (including payout in cash) based on the selection by the user.

### BRIEF DESCRIPTION OF THE DRAWINGS

FIG. 1 is a block diagram showing a constitutional example of an award money payment system;

FIG. 2 is a functional block diagram showing a constitutional example of a gaming machine;

FIG. 3 is a function al block diagram showing a constitutional example of an award ticket information administrating unit;

FIG. 4A is a view showing a data constitutional example of a record which is stored in an award ticket information database unit;

FIG. 4B is a view showing a data constitutional example of a record which is stored in a user information database unit;

FIG. 5 is a functional block diagram showing a constitutional example of an award ticket issuing device;

FIG. 6A is a view showing an example of data which is written in a storage medium which constitutes an award ticket;

FIG. 6B is a view showing an example of data which is written in a storage medium different from the storage medium shown in FIG. 6A;

FIG. 7 is a functional block diagram showing a constitutional example of an award ticket accounting device;

FIG. 8 is a flowchart showing an operational example of the award ticket accounting device;

FIG. 9 is a sequence diagram showing an operational example of an award money payment system;

FIG. 10 is a sequence diagram which follows the sequence diagram shown in FIG. 9;

FIG. 11A is a view showing an example of a screen which is displayed on a user interface unit;

FIG. 11B is a view showing an example of a screen which is displayed on a user interface unit;

FIG. 11C is a view showing an example of a screen which is displayed on a user interface unit;

FIG. 11D is a view showing an example of a screen which is displayed on a user interface unit; and

FIG. 11E is a view showing an example of a screen which is displayed on a user interface unit.

### DESCRIPTION OF THE PREFERRED EMBODIMENTS

An award money payment system and an award money payment method which is realized as an operation of the award money payment system according to an embodiment of the present invention are explained in conjunction with drawings hereinafter.

[1. Constitutional Example of Award Money Payment System]

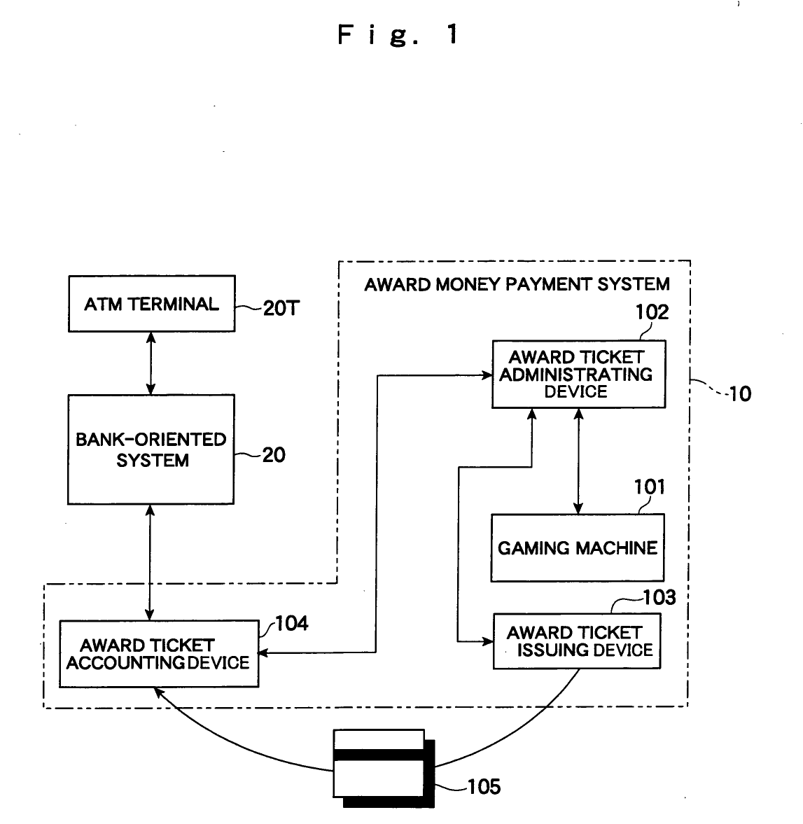

First of all, a constitutional example of the whole award money payment system is explained in conjunction with FIG. 1. FIG. 1 is a block diagram showing the constitutional example of the award money payment system according to an embodiment of the present invention.

The award money payment system 10 issues an award ticket 105 for receiving the payment of an award money which a user acquires by winning an award, performs the payment of the award money after confirming the authenticity of the issued award ticket 105, and performs payment of the award money by distributing the award money based on the designation by the user such that some award money is transferred to a transaction account (a transfer destination account) and the remaining award money is paid out in cash.

Here, “the award ticket” means a recording medium which stores information which is readable by the award ticket accounting device 104 and is exchangeable with money or a part which contains such a storage medium. In this specification, the award ticket may be an IC card, a magnetic card, a paper sheet to which a barcode is applied or the like, for example. Further, although the “award ticket” is referred in this specification for facilitating the understanding of the invention, the award ticket does not always have a shape and a material as a “ticket” and may have any shape and material provided that the award ticket constitutes a portion which can be read by the award ticket accounting device 104. For example, as the award ticket which can be used in this specification, it is possible to use a medal-type token which incorporates an IC chip therein, a strap which is provided with an IC tag or the like.

The award money payment system 10 includes a gaming machine 101 which determines the winning of the award and decides an award amount, an award ticket administrating device 102 which is connected with the gaming machine 101, the award ticket issuing device 103 which is connected with the award ticket administrating device 102, and an award ticket accounting device 104 which is connected with the award ticket administrating ticket 102. Here, the award ticket accounting device 104 is connected with a bank-oriented system 20 of a system which constitutes a system different from the award money payment system 10. Further, to the bank-oriented system 20, an ATM (Automated Teller Machine) 20T by which the user receives the payout of the award money transferred to the transfer destination account is connected so that the user can draw the distributed cash corresponding to the whole or a portion of the award money.

Hereinafter, the respective constitutional elements of the award money payment system 10 are explained.

[1.1. Gaming Machine]

The gaming machine 101 is a device which is configured to allow the user to acquire the award money under predetermined conditions and is, for example, a slot machine, a card game machine with which users can play poker, black jack and the like, a public lottery unit, a bingo game unit, pachinko, pachinko slot machine or the like.

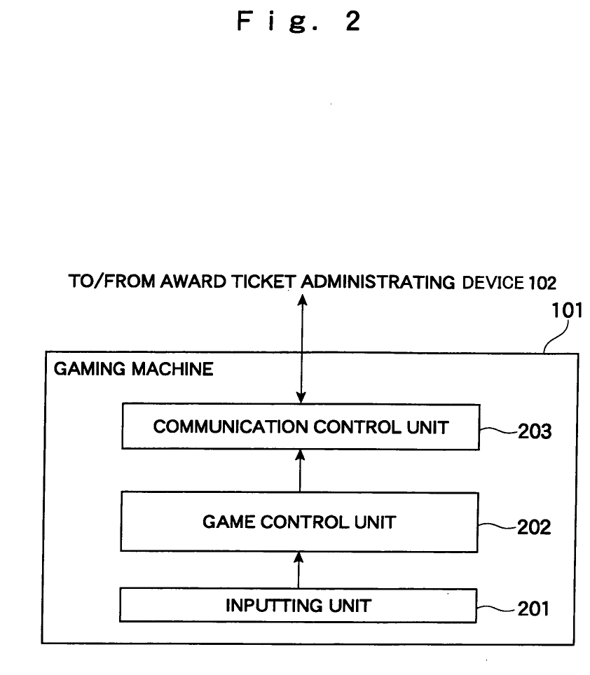

FIG. 2 shows a constitutional example of the gaming machine 101. In the constitutional example shown in the drawing, the gaming machine 101 includes an inputting unit 201 which receives a control from the user, a game control unit 202 which executes a game or the like in accordance with a signal from the inputting unit 201 and determines the winning or the losing of the award and the decision of the award amount, and a communication control unit 203 which, upon receiving information on the winning of the award and the information indicative of the award amount from the game control unit 202, establishes the connection between the communication control unit 203 and the award ticket administrating device 102 and transmits these information to the award ticket administrating device 102.

[1.2. Award Ticket Administrating Device]

The award ticket administrating device 102 has a function of receiving and storing information indicative of the winning of the award and the information indicative of the award money from the gaming machine 101 and a function of instructing the award ticket issuing device 103 to issue the award ticket 105 based on these information. Further, the award ticket administrating device 102 also has a function of performing the identification of an award ticket accounting requester based on the identification information transmitted from the award ticket accounting device 104. Here, “identification information” is information which is capable of confirming the identity between the award ticket accounting requester and a person who receives the issuance of the award ticket 105. The identification information may be, for example, information for so-called biometrics identification (vocal print, finger print, retina, iris, facial image, vein pattern or the like), ID, password or the like.

The award ticket administrating device 102 is a unit which includes an arithmetic processing unit (CPU), a main memory (RAM), a read-only memory (ROM), an input/output unit (I/O), and an external storage unit such as a hard disc unit or the like. The award ticket administrating device 102 is also an information processing unit which is constituted of, for example, a computer, a work station, a WWW (World Wide Web) server, or a combination of the WWW server, a database server and an application server. In the above-mentioned ROM, the hard disc unit or the like, a program which allows the information processing unit to function as the award ticket administrating device 102 or a program which allows the computer to partially execute the award ticket payment method is stored. By introducing the program to the main memory and by allowing the CPU to execute the program, the award ticket administrating device 102 is realized or the award ticket payment method is partially executed. Further, the above-mentioned program is not always stored in the storage unit in the inside of the information processing unit and may be provided from an external unit (for example, ASP (server of application service provider) and may be introduced into the main memory.

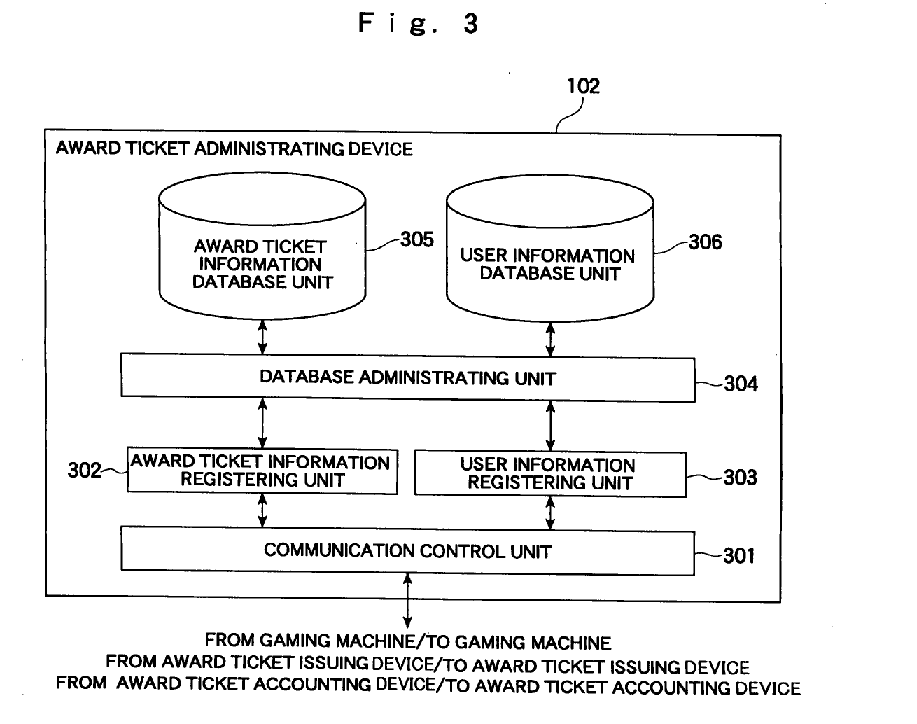

FIG. 3 is a functional block diagram showing a constitutional example of the award ticket administrating device 102. The award ticket administrating device 102 includes a communication control unit 301 which serves to perform the communication connection of the award ticket administrating device 102 with the gaming machine 101, the award ticket issuing device 103 and the award ticket accounting device 104, an award ticket information registering unit 302 and an identification executing unit 303 which are connected with the communication control unit 301, a database administrating unit 304 which is connected with the award ticket information registering unit 302 and the identification executing unit 303, and an award ticket information database unit 305 and a user information database unit 306 which are connected with the database administrating unit 304.

The communication control unit 301 establishes the communication with the gaming machine 101 and the like by executing a predetermined communication protocol (protocol stack) and performs the transmission/reception of the data. The award ticket information registering unit 302, upon receiving the information on the winning of the award and the award amount from the gaming machine 101, instructs the award ticket information database unit 305 to store the data on the award ticket 105 based on these information. The identification executing unit 303 compares the identification information transmitted from the award ticket accounting device 104 with the stored identification information corresponding to the award ticket 105 which is stored in the award ticket information database unit 305 or the user information database unit 306 thus performing the determination of identification. Then, the identification executing unit 303 instructs to notify a result of the identification determination to the award ticket accounting device 104 by way of the communication control unit 301. The database administrating unit 304, in response to a request from the award ticket information registering unit 302 and the identification executing unit 303, performs the writing of data, the reading of data and the like to and from the award ticket information database unit 305 and the user information database unit 306.

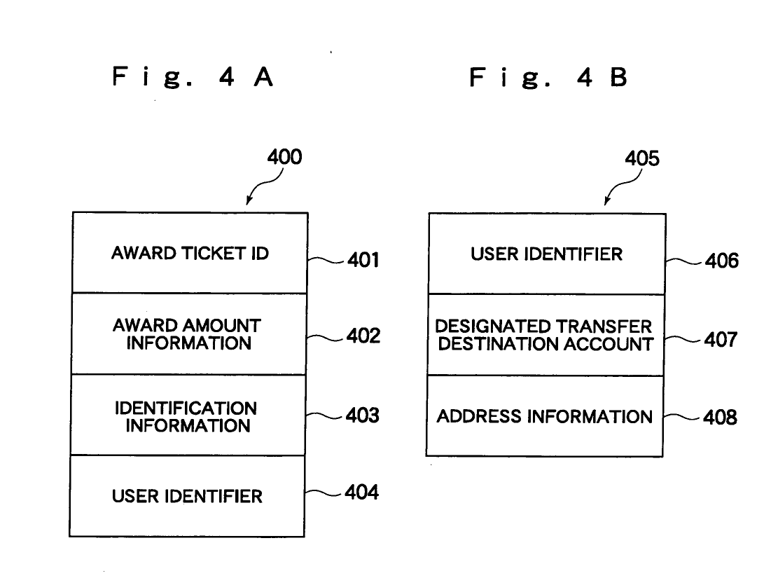

The award ticket information database unit 305 stores information for specifying the award ticket 105 and the information indicative of the award money with respect to one award ticket 105 and the information indicative of the holder of the award ticket 105 in a state that these information are related to each other. FIG. 4A is a data constitutional example of a record which the award ticket information database unit 305 stores. The award ticket information database unit 305 stores the record 400 shown in FIG. 4A for every one award ticket 105, wherein each record 400 includes an award ticket ID 401 which is information for specifying the award ticket 105, award amount information 402 which is information indicative of the award money, identification information 403 which is used for the identification, and a user identifier 404 which specifies the holder of the award ticket 105. The identification information 403 is identification information which is acquired at the time of issuing the award ticket at the award ticket issuing device 103.

The user information database unit 306 stores information on the user. FIG. 4B shows the data constitutional example of a record which the user information database unit 306 stores. The user information database unit 306 stores the record 405 shown in FIG. 4B for every user and each record 405 includes a user identifier 406 which is information for specifying the user, transfer destination account information (financial code, branch code, account number and the like) 407 which the user preliminarily designates as the transfer destination account of the award money, and address information (telephone number at home/at work, electronic mail address, address and the like) 408 on the user. In the user information database unit 306, information which is obtained at the time of user registration is mainly stored. The user registration is performed when the user expresses his/her wish to use the award money payment system 10 to a management/administrator of the award money payment system.

The award ticket information database unit 305 and the user information database unit 306 can be referenced with each other using the user identifiers 404, 406 as keys. Accordingly, it is possible to retrieve the stored content of the user information database unit. 306 using the user identifier 404 of the award ticket information database unit 305 as the key and to extract the designated transfer destination account of the user. Here, it is not always necessary to separate the database unit into the award ticket information database unit 305 and the user information database unit 306. That is, the award ticket administrating device 102 can be realized by the constitution in which storage contents of both of the award ticket information database unit 305 and the user information database unit 306 may be handled using one database.

Further, there arises no problem even when the identification information 403 is stored in the user information database unit 306 in place of the award ticket information database unit 305. This is because that by using the user identifier 404 in the inside of the record 400 as the key, it is possible to extract the identification information from the record 405 of the user information database unit 306.

[Award Ticket Issuing Device]

Next, the award ticket issuing device 103 is explained. The award ticket issuing device 103 has a function of preparing and issuing the award ticket 105 which is made relevant to the identification information in cooperation with the award ticket administrating device 102 when the user wins the award in the gaming machine 101.

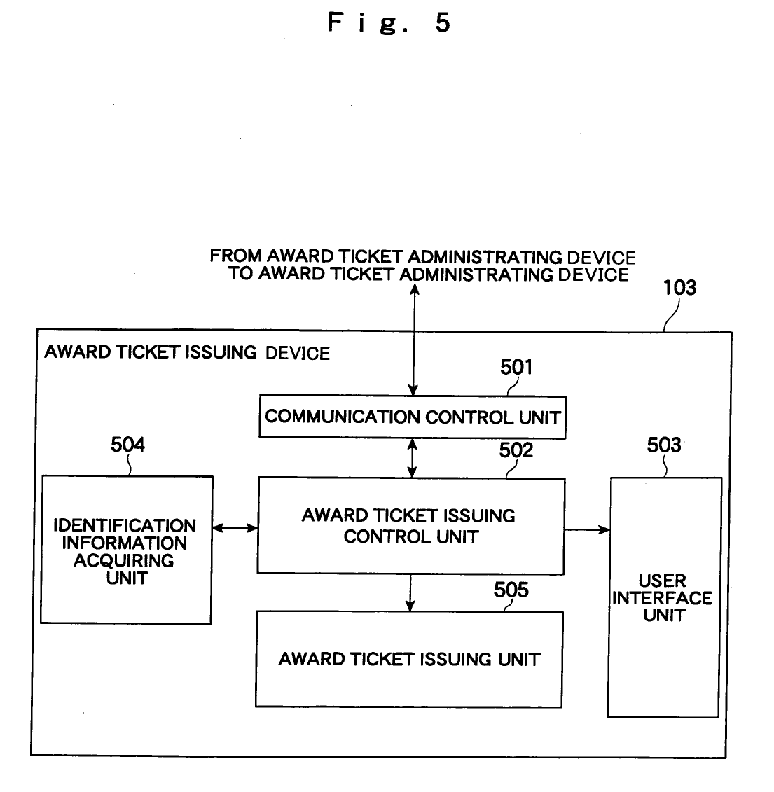

FIG. 5 is a functional block diagram showing a constitutional example of the award ticket issuing device 103. In the constitutional example shown in the drawing, the award ticket issuing device 103 includes a communication control unit 501 which is connected with the award ticket administrating device 102, an award ticket issuing control unit 502 which is connected with the communication control unit 501, a user interface unit 503 which is connected with the award ticket issuing control unit 502, an identification information acquiring unit 504, and an award ticket issuing unit 505.

The communication control unit 501 has a function of performing the transmission/reception of data by establishing the connection between the communication control unit 501 and the award ticket administrating device 102 by executing a predetermined communication protocol (protocol stack).

The award ticket issuing control unit 502 performs the overall control of operations including the operational timing, the starting of the operation, the completion of the operation of the communication control unit 501, the user interface unit 503, identification information acquiring unit 504 and the award ticket issuing unit 505. The award ticket issuing control unit 502 controls and instructs the award ticket issuing unit 505 to write the award ticket ID which is information for identifying the award ticket which is transmitted from the award ticket administrating device 102 on the award ticket 105.

The user interface unit 503 has a function of transmitting messages related to the issuance of the award ticket to the user as well as a function of receiving the inputting of the user and, for example, includes a liquid crystal touch panel and a driver thereof. That is, the user interface unit 503 suitably displays messages such as “Issue the award ticket? YES/NO”, “Register identification information. Place your right forefinger on a scanner.”, “The issuance of the award ticket is completed.”, an execution button, a confirmation button, a cancellation button and the like.

The identification information acquiring unit 504 has a function of acquiring the identification information of an authorized holder of the award ticket 105. For example, the identification information acquiring unit 504 reads out a vocal print, a finger print, a retina, an iris, a facial image, a vein pattern or the like and extracts a pattern from the read-out image data and generates the identification information. The generated identification information is transmitted to the award ticket administrating device 102 by way of the communication control unit 501 and is stored in the award ticket administrating device 102 as a portion of the data 400. Alternatively, the above-mentioned identification information may be transmitted to the award ticket issuing control unit 502 and may be written in the award ticket 105 at the time of issuing the award ticket 105.

The award ticket issuing unit 505 has a function of performing the writing of the information necessary for the payment of the award money to a storage medium which constitutes the award ticket 105 in a state before issuance and a function of outputting the storage medium on which the information is already written as the award ticket 105. With respect to the award ticket issuing unit 505, for example, a card writer of a magnetic card or an IC card or a communication mechanism (an infrared communication mechanism, Bluetooth or the like) which can transmit data to a mobile telephone when the storage medium is a mobile phone can be used as the award ticket issuing unit 505.

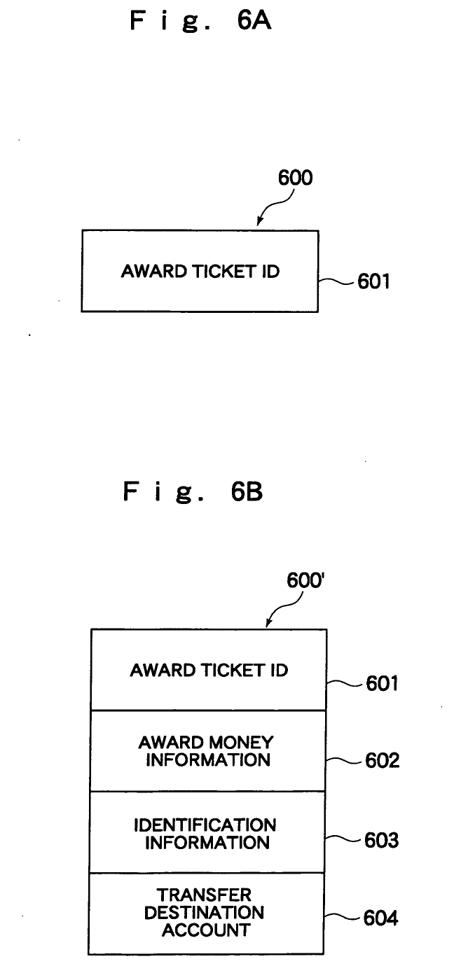

FIG. 6A is a view showing an example of data written in the storage medium which constitutes the award ticket 105 by the award ticket issuing unit 505. In the storage medium, as information 600 necessary for the payment of the award money (the accounting of the award ticket), an award ticket ID 601 is written. FIG. 6B is a view showing another example of data written in the storage medium which constitutes the award ticket 105. In the storage medium (the award ticket 105), as information 600′ necessary for the payment of the award money (accounting of the award money), the award ticket ID 601, an award amount information 602, identification information 603 and a transfer destination account 604 are written. When the information 600′ shown in FIG. 6B is written, the award ticket accounting device 104 can perform the determination of identification and the payout of the award money independently without communicating with the award ticket administrating device 102.

[Award Ticket Accounting Device]

The award ticket accounting device 104, when the user submits the award ticket 105 and also requests for the payment of the award money, has a function of performing the payment in cash and/or the transfer of the award money to the designated transfer destination account in response to the designation by the award ticket bearer (award money payment requester) on the condition that the authenticity of the award ticket 105 is proved and the identification of the award ticket bearer (holder) is established.

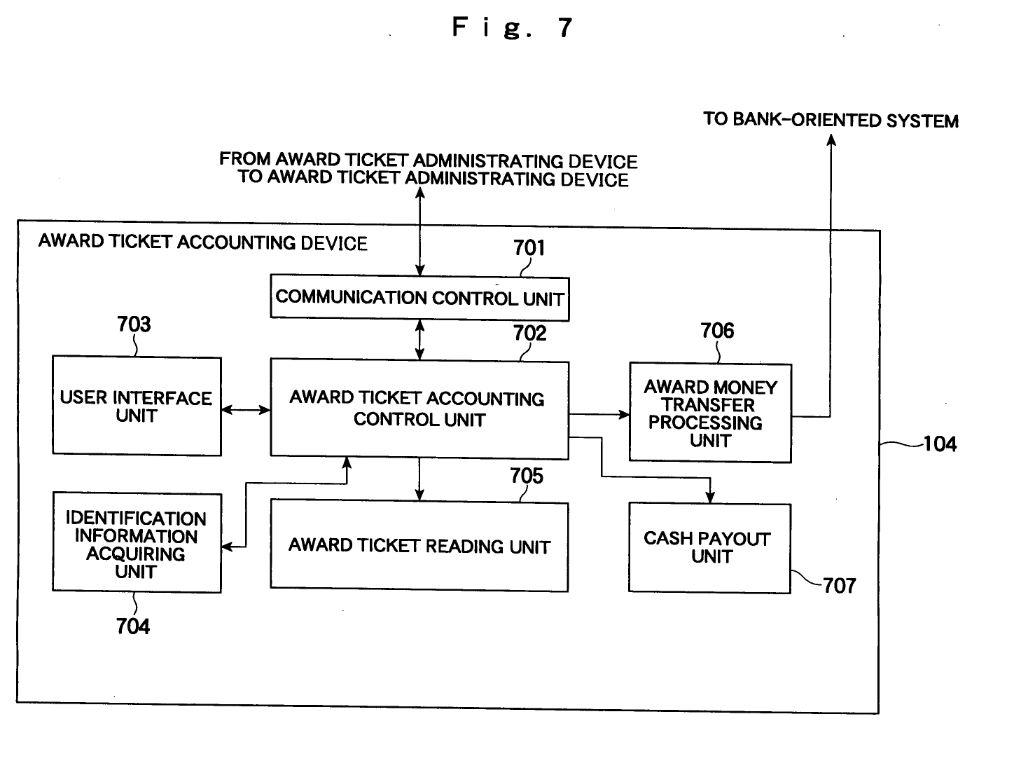

FIG. 7 is a functional block diagram showing a constitutional example of the award ticket accounting device 104. In the constitutional example shown in the drawing, the award ticket accounting device 104 includes a communication control unit 701 which is connected with the award ticket administrating device 101, an award ticket accounting control unit 702 which is connected with the communication control unit 701, a user interface unit 703 which is connected with the award ticket accounting control unit 702, an identification information acquiring unit 704, an award ticket reading unit 705, an award money transfer processing unit 706 and a cash payout unit 707. Here, the award money transfer processing unit 706 is communicably connected with the bank-oriented system 20.

The communication control unit 701 has a function of establishing the connection with the award ticket administrating device 102 so as to perform the transmission/reception of data by executing the given communication protocol (protocol stack).

The award ticket accounting control unit 702 performs the overall control of operations including the instruction of operation starting timing and the instruction of the completion of the operation of the communication control unit 701, the user interface unit 703, the identification information acquiring unit 704, the award ticket issuing unit 705, the award money transfer processing unit 706 and the cash payout unit 707. Further, the award ticket accounting control unit 702 performs the personal determination by collating the identification information which is acquired by the identification information acquiring unit 704 with the identification information 603 stored in the award ticket administrating device 102 or the award ticket 105. When the personal determination proves to be successful, the award ticket accounting control unit 702 transmits the various information (the award amount information 402, the transfer destination account 604 and the like) which are stored in the award ticket 105 to the award money transfer processing unit 706 and instructs the award money transfer processing unit 706 to perform the transfer processing of the award money to the designated transfer destination account and, at the same time, instructs the cash payout unit 707 to pay out the designated amount in cash when the cash payout is designated.

The user interface unit 703 has a function of transmitting messages related to the accounting of the award ticket to the user as well as a function of receiving the inputting of the user. For example, the user interface unit 703 includes a liquid crystal touch panel and a driver thereof. That is, the user interface unit 703 suitably generates and displays messages such as “Account the award ticket ? YES/NO”, “Confirm identification. Place your right forefinger on a scanner.”, “The accounting of the award ticket is completed. The award money of 70,000 yen is transferred to the account number 123456 of Tokyo Branch of the Metropolitan Bank designated by the user and the remaining 30,000 yen is paid out in cash.”, an execution button, a confirmation button, a cancellation button and the like.

Further, the user interface unit 503 may include a reader for a cash card and a transfer card as a unit by which the user designates the transfer destination account.

The identification information acquiring unit 704 includes a function of acquiring the identification information of a person who requests the accounting of the award ticket 105. This identification information is of the same kind as the identification information acquired by the award ticket issuing device 103. The acquired identification information is transmitted to the award ticket accounting control unit 702 and is served for the personal determination processing.

The award ticket reading unit 705 has a function of reading the data written in the award ticket 105 which is submitted by the person who requests the accounting of the award ticket 105 and of transmitting the data to the award ticket accounting control unit 702. With respect to the award ticket accounting device 705, for example, a card reader for a magnetic card or an IC card or a communication mechanism (an infrared communication mechanism, Bluetooth or the like) which can transmit data to a mobile telephone when the storage medium is a mobile phone can be used as the award ticket issuing unit 705.

The award money transfer processing unit 706, when the award ticket accounting control unit 702 is successful in the personal determination, has a function of requesting the bank-oriented system 20 to transfer the whole award money or the designated amount out of the award money to the transfer destination account based on the information written in the award ticket 105 and the information designated by the user interface unit 503.

The cash payout unit 707, when the award ticket accounting control unit 702 is successful in the personal determination, has a function of paying out the designated amount based on the information written in the award ticket 105 and the information designated by the user interface unit 503. The cash payout unit 707 is a mechanism which corresponds to a cash payout machine, for example, wherein bills and coins are periodically replenished by an administrator. The cash payout unit 707 is operated to pay out bills/coins corresponding to the designated cash in accordance with the cash payout instruction from the award ticket accounting control unit 702.

[Operational Example of Award Ticket Accounting Device]

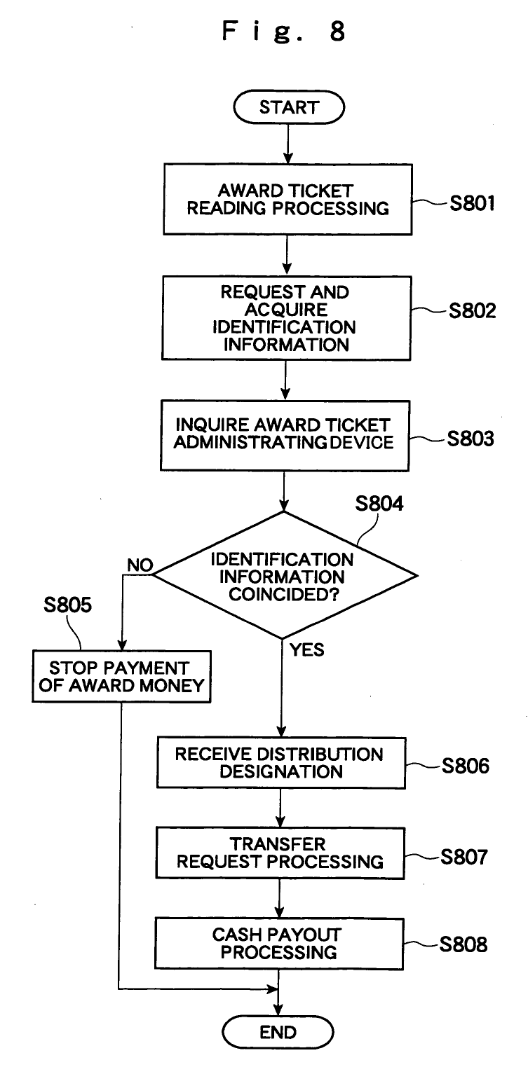

Next, an operational example of the award ticket accounting device 104 is explained in conjunction with FIG. 8. FIG. 8 is a flow chart showing the operational example of the award ticket accounting device 104.

When the user requests the accounting processing of the award ticket 105 by touching user interface unit 703 of the award ticket accounting device 104, the award ticket accounting device 104, first of all, performs the reading processing of the award ticket 105 (step S801). For example, the award ticket accounting device 104 urges the user to insert the award ticket 105 into a card reader which constitutes the award ticket reading unit 704. When the user inserts the award ticket 105 into the card reader (award ticket reading unit 705, the card reader reads the data written in the award ticket 105 and transmits the data to the award ticket accounting control unit 702.

Next, the award ticket accounting device 104 requests the identification information to the user and performs the identification of the person who requests the accounting by the identification information acquiring unit 704 (step S802). For example, the award ticket accounting device 104 instructs the user interface unit 703 to display a message “The identification is performed. Place your right forefinger on a scanner.” and urges the user to provide fingerprint information which constitutes the identification information. The identification information acquiring unit 704 optically reads the fingerprint information, generates a characteristic pattern from this optically obtained image data, and transmits the image data to the award ticket accounting control unit 702 as the identification information.

Next, the award ticket accounting device 104 transmits the information (the award ticket ID 601) which is read by the award ticket 105 in step S801 and the personal confirmation information which is acquired in step S802 to the award ticket administrating device 102 and requests the execution of the identification determination and the transmission of the information on the award ticket (for example, the award amount information 402, the designated transfer destination account 407) (step S803).

The award ticket administrating device 102, replying to the request for the execution of the identification determination and the transmission of the information on the award ticket, performs the identification determination by comparing and collating the identification information transmitted from the award ticket accounting device 104 and the identification information 403 stored in the award ticket administrating device 102. When these identification coincide with each other, the identification is established and hence, the identification determination proves to be successful. On the other hand, when these identification do not coincide with each other, the identification is not established and hence, the identification determination proves to be unsuccessful.

When the identification determination proves to be successful, the award ticket administrating device 102 transmits the identification success message and the information on the award ticket to the award ticket accounting device 104. On the other hand, when the identification determination proves to be unsuccessful, the award ticket administrating device 102 transmits the identification failure message to the award ticket accounting device 104.

The award ticket accounting device 104 determines the identity of the bearer of the award ticket (the coincidence of the holder/person to which the award ticked is issued and the bearer of the award ticket) based on the identification success message/identification failure message transmitted from the award ticket administrating device 102 (step S804). When the identity is not recognized (step S804, No), the award ticket accounting device 104 stops the award ticket accounting processing (step S805) and finishes the whole processing. Accordingly, it is possible to prevent the illegal acquisition of the award ticket or the illegal acquisition of the award money by a person who disguises as the user.

On the other hand, when the identity is recognized (step S804, Yes), the award ticket accounting device 104 receives an input of distribution designation which designates a portion of the award money to be transferred to the designated transfer destination account and a remaining portion of the award money to be paid out in cash (step S806).

Next, the award ticket accounting device 104 requests the bank-oriented system 20 to perform the transfer processing with respect to the amount which is designated to be transferred to the transfer destination account (step S807) and discharges the amount which is designated to be paid out in cash from the cash payout unit 707.

Here, the distribution designation is not limited to a case in which the amount is directly designated and may be performed based on a percentage which is expressed such as “transfer: 70%, cash: 30%” or based on a rate which is expressed as “transfer:cash=7:3. Further, the distribution designation in which the distribution of either one of the transfer and the cash is 0 is also included in the mode of carrying out the present invention.

Further, although the explanation is made with respect to the case in which the number of transfer destination account is one, it is possible to apply the present invention to two or more transfer destination accounts.

The description made above explains the operational example of the award ticket accounting device 104.

[With Respect to an Operational Example of the Award Money Payment System]

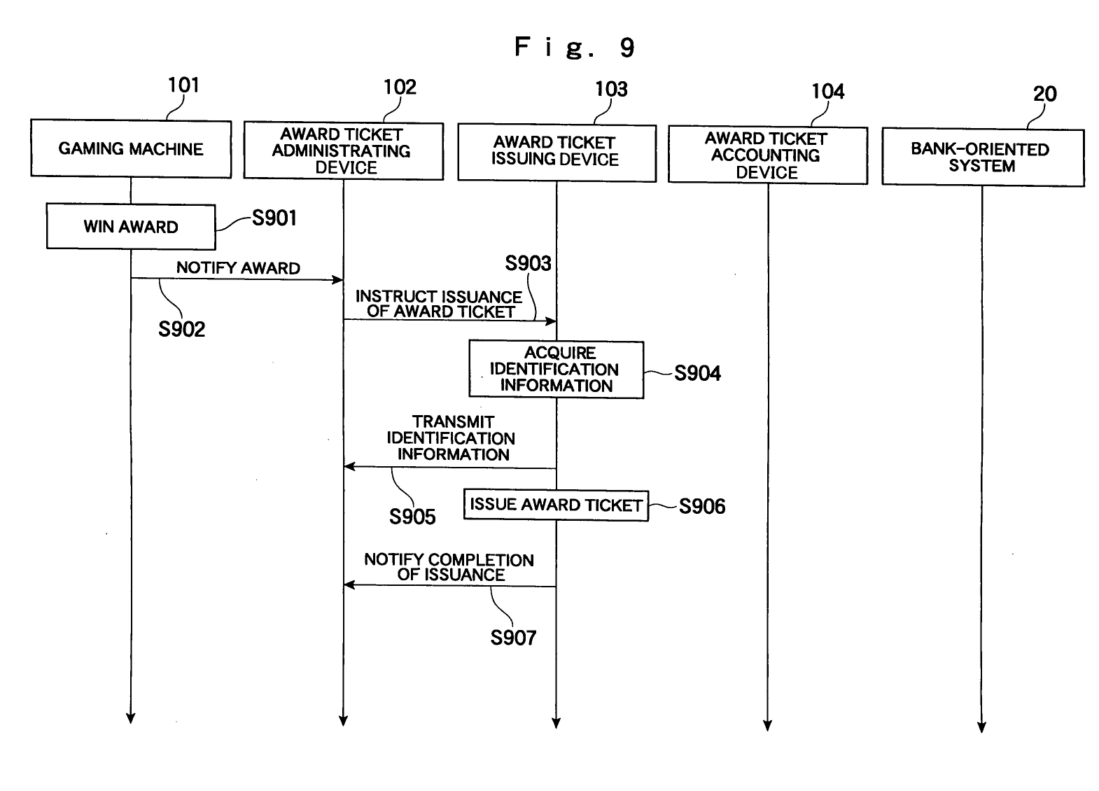

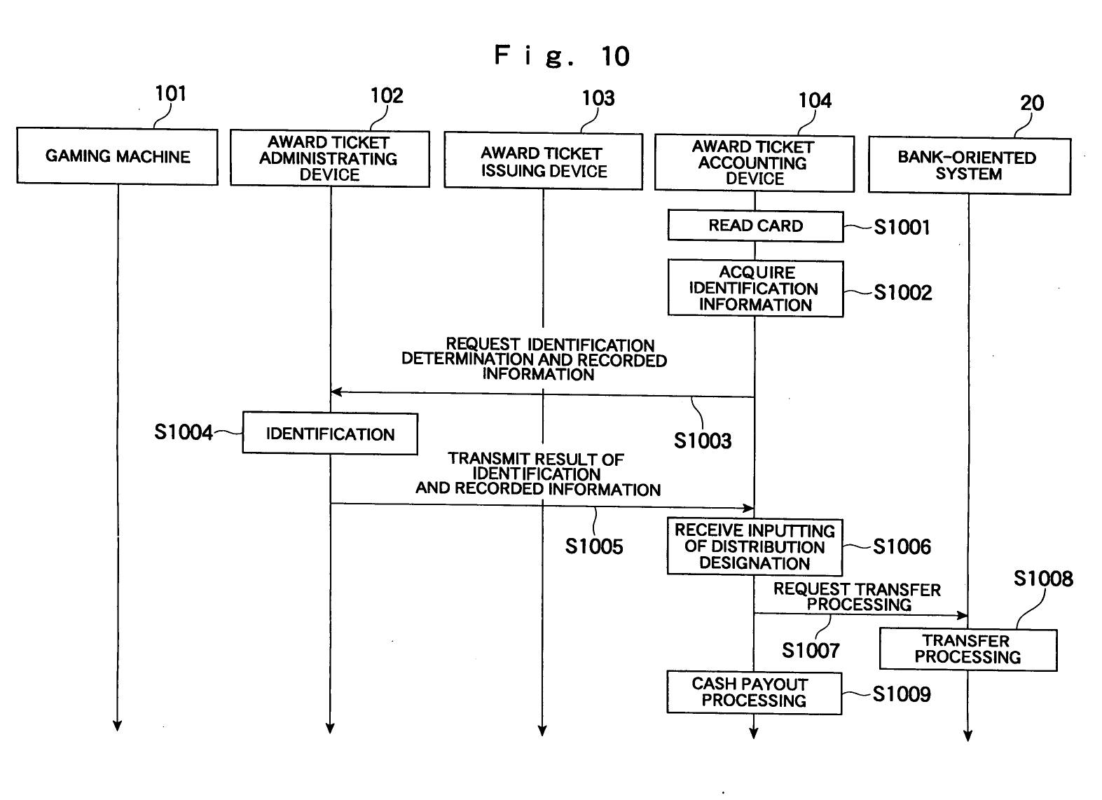

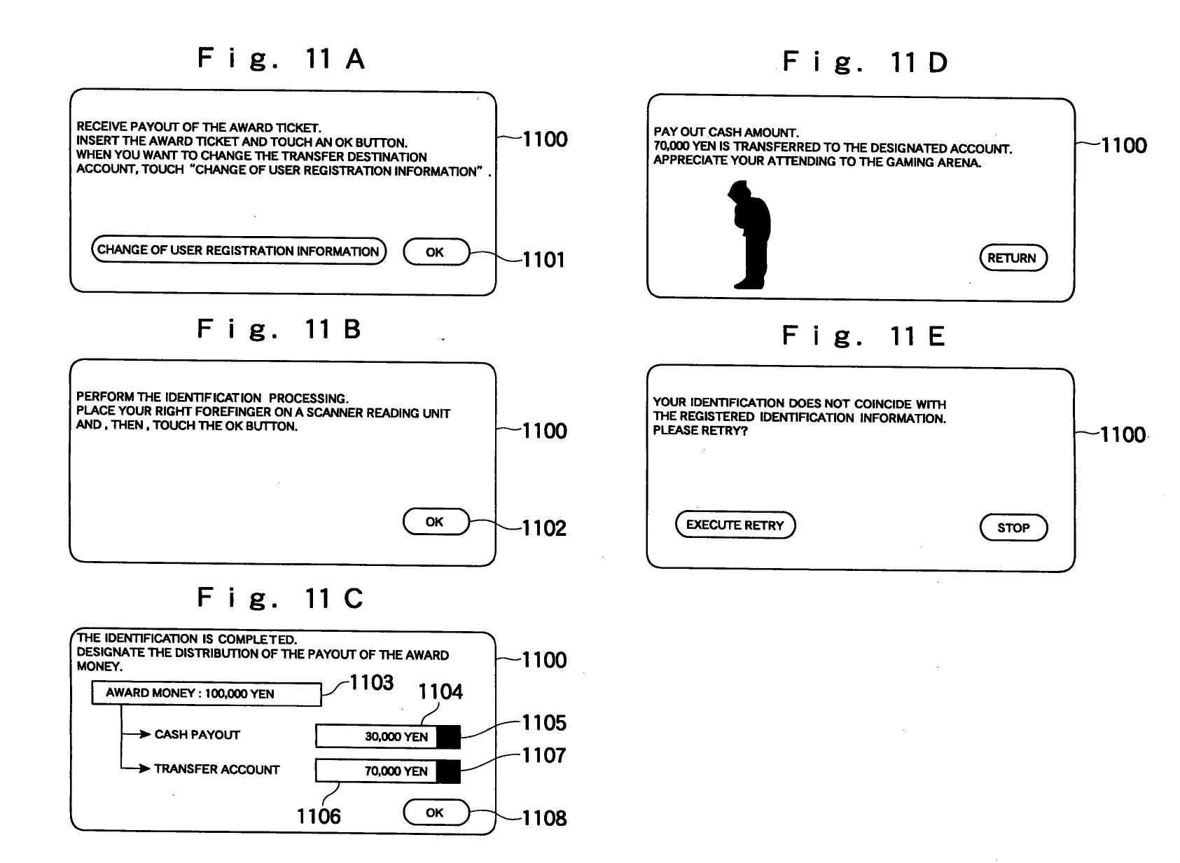

Next, an operational example of the award money payment system according to this embodiment is explained in conjunction with FIG. 9, FIG. 10 and FIG. 11A to FIG. 11E. FIG. 9 is a sequence diagram showing an operational example of the award money payment system, FIG. 10 is a sequence diagram which shows an operational example of the award money payment system which follows the operational example shown in FIG. 9, and FIG. 11A to FIG. 11E are screen examples displayed on a liquid crystal display which constitutes the user interface unit 703 of the award ticket accounting device 104.

First of all, the operational example up to the issuing of the award ticket 105 is explained in conjunction with FIG. 9.

Assume that the user wins the award in the game using the gaming machine 101 and the award money is produced (step S901). Then, the gaming machine 101 notifies the award ticket administrating device 102 that the user wins the award and the award amount thereof (step S902). In response to the notification, the award ticket administrating device 102 performs the issuing and the recording of the award ticket ID 401 and, thereafter, performs the storing of the award amount information 402.

Next, the award ticket administrating device 102 transmits an award ticket issuing command to the award ticket issuing device 103 together with the information necessary for issuing the award ticket 105 (for example, the award ticket ID 401 and the like)(step S903).

The award ticket issuing device 103 urges the user to input the identification information. When the user responds to this urging and performs predetermined operations and controls, the award ticket issuing device 103 acquires the identification information of the user who is the holder of the award ticket (step S904). The award ticket issuing device 103 transmits the acquired identification information to the award ticket administrating device 102 (step S905). The award ticket administrating device 102 stores the received identification information in a state that the identification information is related with the award ticket ID 401 (see FIG. 4) so as to be ready for the request for the identification determination from the award ticket accounting device 104 which follows thereafter.

Next, the award ticket issuing device 103 performs the writing processing of the information received in step S903 into the storage medium which constitutes the award ticket 105 and issues the storage medium in which the information is written as the award ticket 105 (step S906). The issued award ticket 105 is acquired by the user and the user has only to keep the award ticket 105 until the user performs the accounting of the award ticket 105.

Further, it may be possible that when the issuing of the award ticket (step S906) is completed, the award ticket issuing device 103 informs the award ticket administrating device 102 that the issuing of the award ticket 105 is completed (step S907). The award ticket administrating device 102, by storing the issuing date of the award ticket 105, can administrate the period of validity of the award ticket 105 (for example, the accounting of the award ticket 105 can be performed within one month from the issuing of the ticket and, after one month has passed, the award ticket 105 is made invalid or the like).

Next, the operational example of the award money payment system according this embodiment at the accounting of the award ticket is explained in conjunction with FIG. 10 and FIG. 11A to FIG. 11E.

First of all, to request the award money payment processing, the bearer of the award ticket 105 allows the award ticket accounting device 104 to perform the reading out of the award ticket 105 (step S1001). To identify the bearer of the award ticket as the person to whom the award ticket is issued, the award ticket accounting device 104 requests the user to input the identification information and acquires the identification information of the user who responds to this inputting (step S1002). FIG. 11A is a screen example which is displayed on the user interface unit 703 (liquid crystal display) of the award ticket accounting device 104 and stands by the starting of the award ticket accounting processing. On a display region 1100, a message, a button 1101 which starts the award ticket accounting processing and like are displayed. A touch panel is incorporated into the user interface unit 703. When the user touches the button 1101, the screen is shifted to a screen shown in FIG. 11B. FIG. 11B shows an example of the screen which is displayed on the user interface unit 703 and urges the user to input the identification information. When the user finishes the input preparation of the identification information in accordance with the instruction on the screen and, thereafter, touches a button 1102, the acquisition of the identification information is executed.

When the acquisition of the identification information is finished, the award ticket accounting device 104 transmits the information which is read from the award ticket 105, that is, the award ticket ID 601 and the acquired identification information to the award ticket administrating device 102 and, at the same time, requests the identification determination and the transmission of the information 400 stored corresponding to the award ticket ID 601 (step S1003).

The award ticket administrating device 102 compares the identification information which is transmitted in step S1003 and the identification information 403 stored in the award ticket administrating device 102 so as to perform the identification determination. When the identity is recognized as a result of the identification determination, the award ticket administrating device 102 transmits the identification success message, the recorded information 400, 405 and the like to the award ticket accounting device 104 (step S1005).

Next, the award ticket accounting device 104 receives a distribution designation input from the user (step S1006). FIG. 11C shows a screen example which is displayed on the user interface unit 703 to receive the distribution designation input. In this screen example, within the display area 1101, a region 1103 which shows a total amount of the award money is provided. Further, within the display area 1101, a region 1104 which designates an amount to be paid out in cash which constitutes the distribution designation input and a region 1106 which designates an amount to be transferred to the account which also constitutes the distribution designation input are provided. The amounts which are displayed in the inside of the regions 1104, 1106 can be increased or decreased using a pointing unit or the like. Further, a sum of the amounts in the inside of the regions 1104, 1106 is always interlocked with a total sum shown in the region 1103 and is controlled such that when one is increased (decreased), another is automatically decreased (increased).

Further, “account transfer” is linked with the designated transfer destination account 407. By pointing or clicking the “account transfer” with the pointing unit, a bank name, a branch name, an account number and the like are displayed on an arbitrary position in the inside of the region 1101 and hence, the user can confirm the transfer destination.

By setting the amounts in the inside of the regions 1104, 1106 to amounts which the user desires and by activating the button 1108 by clicking or the like, the distribution designation inputting is completed and the award ticket accounting device 104 performs the payment of the award in accordance with the distribution designation inputting. That is, the award ticket accounting device 104 transmits the transfer processing request to the bank-oriented system 20 so that the bank-oriented system 20 transfers the designated amount to the transfer destination account in the region 1106 (step S1007). The bank-oriented system 20, in response to the transfer processing request, performs the processing to transfer an amount corresponding to the award money to the transfer destination account (step S1008). Further, the award ticket accounting device 104 pays out the amount designated in the region 1105 by the cash payout unit 707 in cash.

FIG. 11D shows a screen example which is displayed on the user interface unit 703 of the award ticket accounting device 104 after completion of steps S1007, S1008. In this screen example, a message which informs the user of the fact that the payout in cash is performed in accordance with the distribution designation inputting is displayed.

With the above-mentioned operations, the accounting processing of the award ticket (the payment processing of the award ticket) by the award money payment system of the present invention is completed.

Here, when the identification in step S1004 turns out to be unsuccessful, the award ticket administrating device 102 transmits the identification failure message to the award ticket accounting device 104. Upon receiving the identification failure message, the award ticket accounting device 104 stops the accounting processing of the award ticket 105. FIG. 11E shows a screen example which is displayed on the user interface unit 703 of the award ticket accounting device 104 when the award ticket accounting device 104 receives the identification failure message.

[Modification and the Others]

(1) Although, in the above-mentioned embodiment, the identification information of the holder of the award ticket (the person to whom the award ticket is issued) is stored in the award ticket administrating device 102, the present invention is also established by a constitution in which an identification server which stores and administrates the identification information is provided separately and the award ticket accounting device 104 accesses this identification server and acquires the identification information of the holder of the award ticket (the person to whom the award ticket is issued).

(2) Although the above-mentioned embodiment has the constitution in which the award ticket administrating device 102 is provided to store and administrate the information with respect to the award ticket 105, the present invention is also established by a constitution in which all of the information with respect to the award ticket 105 is stored in the award ticket 105 and the award ticket administrating device 102 is not provided.

(3) Although the above-mentioned embodiment has the constitution in which the requesting of the opening of the transfer destination account is transmitted from the award ticket accounting device 104 to the bank-oriented system 20, the present invention is also established by a constitution in which the award ticket administrating device 102 transmits the requesting of the transfer of the award money to the transfer destination account to the bank-oriented system 20.

(4) Although the above-mentioned embodiment has the constitution in which the determination of the identification information is performed by the award ticket administrating device 102, the determination of the coincidence of the identification information may be performed in the award ticket accounting device 102.

1. An award money payment system which pays a predetermined award money to a user when the user wins an award in a game, the award money payment system comprising:
an award ticket issuing device which issues an award ticket which is related with identification information of the user when the user wins an award in a gaming machine; and
an award ticket accounting device which reads out information stored in the award ticket and acquires identification information of a bearer of the award ticket, and is instructed to account and distribute the award money in cash and to transfer the award money into a transfer destination account in accordance with a distribution designation input on a condition that the identification of the bearer of the award ticket based on the identification information is established.

2. An award money payment system according to claim 1, wherein the award ticket issuing device includes:
an identification information acquiring unit which acquires identification information of a holder of an award ticket upon reception of a notification of winning of an award; and
an award ticket issuing unit which stores the identification information which is acquired by the identification information acquiring unit and award ticket identification information in a state that the identification information and the award ticket identification information are related to each other.

3. An award ticket accounting device comprising:
an input receiving unit which receives a distribution designation input of an award money by a bearer of an award ticket;
an identification information acquiring unit which acquires identification information of the bearer of the award ticket;
an award ticket accounting control unit which reads award ticket identification information which is stored in the award ticket, acquires the identification information of a holder of the award ticket based on the award ticket identification information, and instructs the input receiving unit to receive the distribution designation input based on a result of identification using the identification information of the bearer of the award ticket acquired by the identification information acquiring unit and the identification information of the holder of the award ticket; and
a transfer processing unit which performs the transfer of the whole or a portion of the award money to a transfer destination account in accordance with the distribution designation input.

4. An award ticket accounting device according to claim 3, further comprising a cash payout unit which pays out a cash in accordance with the distribution designation input.
